(19) United States
(12) Patent Application Publication
(10) Pub. No.: US 2002/0130543 A1
(43) Pub. Date: Sep. 19, 2002

(54) Bed chair structure

(76) Inventor: Wei-Luen Tsai, Taichung (TW)

Correspondence Address: Wei-Luen Tsai, 58, MA YUAN WEST ST., TAICHUNG, TW

(21) Appl. No.: 09/811,245

(22) Filed: Mar. 15, 2001

(51) Int. Cl. B60N 2/02

(52) U.S. Cl. 297/354.13

(57) ABSTRACT

A bed chair structure includes an inverted U-shaped seat backrest frame and a U-shaped seat cushion frame connected by normal directional gears. The seat backrest frame has two sides each provided with an upper reinforcing frame which is connected with the seat cushion frame by an armrest upright rod and an armrest transverse rod. The total length of the armrest transverse rod and the armrest upright rod is greater than the length between the upper reinforcing frame and the seat cushion frame, such that the armrest transverse rod and the armrest upright rod can form an inverted V-shaped structure. In such a manner, the armrest transverse rod and the armrest upright rod can be adapted to function as an armrest automatically when the bed chair structure is in turn converted from a bed into a chair.

### BACKGROUND OF THE INVENTION

1. Field of the Invention

The present invention relates to a bed chair structure, and more particularly to a bed chair structure, wherein the armrest transverse rod and the armrest upright rod can be adapted to function as an armrest automatically when the bed chair structure is in turn converted from a bed into a chair.

2. Description of the Related Prior Art

A first conventional bed chair structure in accordance with the prior art shown in FIGS. 1-3 comprises an inverted U-shaped seat backrest frame 1, and a U-shaped seat cushion frame 2, wherein the seat backrest frame 1 and the seat cushion frame 2 are connected by normal directional gears 3, such that the bed chair structure can be transferred into a bed as shown in FIG. 2 or a chair as shown in FIG. 1. The seat backrest frame 1 has two sides each provided with an upper reinforcing frame 6, and the seat cushion frame 2 has two sides each provided with a lower reinforcing frame 7. The upper reinforcing frame 6 and lower reinforcing frame 7 are respectively connected by an armrest transverse rod 4 and an armrest upright rod 5. The armrest transverse rod 4 has a first end pivoted with the bottom end of the upper reinforcing frame 6, and a second end pivoted with a first end of the armrest upright rod 5 whose second end is pivoted with the rear end of the lower reinforcing frame 7 by a normal directional gear 3. However, the first conventional bed chair structure uses excessive numbers of normal directional gears 3, thereby increasing cost of fabrication.

Referring to FIGS. 4-6, in a second conventional bed chair structure in accordance with the prior art, the normal directional gear 10 is pivoted on the bottom of the upper reinforcing frame 13 instead of being pivoted on the bottom of the armrest upright rod 12. However, the second conventional bed chair structure employs excessive numbers of normal directional gears 10, thereby increasing the cost of fabrication.

Referring to FIGS. 7-10, in a third conventional bed chair structure in accordance with the prior art, the seat backrest frame 42 and the seat cushion frame 15 are connected by normal directional gears 25. The seat cushion frame 15 has two sides each secured with an extension rod 18 by soldering. The rear end of the extension rod 18 is secured with an inverted U-shaped rod 17 and a normal directional gear 25 by soldering. The seat cushion frame 15 has two legs each secured with a connector 32 by soldering, and a transverse rod 35 is secured between the two legs of the seat cushion frame 15 by soldering.

The seat backrest frame 42 has two legs each secured with an upper reinforcing frame 16 whose distal end is secured with a connector 19 by soldering. The upper reinforcing frame 16 and the seat cushion frame 15 are connected by an armrest transverse rod 23 and an armrest upright rod 29. A rivet 22 in turn extends a through hole 21 defined in the connector 19 and a through hole 24 defined in the armrest transverse rod 23. The front end of the armrest transverse rod 23 is secured with a connector 26 by soldering. A rivet 27 in turn extends through a through hole 28 defined in the connector 26 and a through hole 30 defined in the armrest upright rod 29. A rivet 34 in turn extends through a through hole 33 defined in the connector 33 and a through hole 31 defined in the front end of the armrest upright rod 29.

As shown in FIG. 8, a locking column 37 is secured on the connector 26 located adjacent to a rear lower end of the through hole 28. As shown in FIG. 10, the locking column 37 is mounted on the front lower end or the central lower end of each connector, so that the armrest transverse rod 23 and the armrest upright rod 29 form an inverted V-shaped structure. Thus, when the bed chair structure is converted from a bed into a chair, the pivotal connection of the armrest upright rod 29 and the seat cushion frame 15 or the pivotal connection of the armrest transverse rod 23 and the upper reinforcing frame 16 needs not to additionally install the normal directional gear 25, thereby greatly decreasing the cost of fabrication.

Referring to FIGS. 11-14, in a fourth conventional bed chair structure in accordance with the prior art, a connector 38 is secured on the rear end of the armrest upright rod 29 by soldering, and a linking member 39 is secured on the front end of the armrest transverse rod 23 by soldering. The linking member 40 defines a through hole 40 for receiving a pivot axle 41 formed on the connector 38. The front end of the connector 38 is formed with a protruding block 36, such that the armrest transverse rod 23 and the armrest upright rod 29 can form an inverted V-shaped structure by locking of the protruding block 36 between the connector 38 and the linking member 39.

### SUMMARY OF THE INVENTION

The present invention has arisen to mitigate and/or obviate the disadvantage of the conventional bed chair structures.

In accordance with the present invention, there is provided a bed chair structure comprising:

a seat cushion frame having two legs;

two armrest upright rods each having a first end pivoted with a respective leg of the seat cushion frame;

a seat backrest frame having two legs;

two upper reinforcing frames each having a first end secured on a respective leg of the seat backrest frame; and

two armrest transverse rods each having a first end pivoted with a second end of a respective upper reinforcing frame and a second end pivoted with a second end of a respective armrest upright rod;

wherein, according to the principle of triangle, the sum of the lengths of two sides of the triangle is greater than the length of the third side of the triangle;

a total length of the armrest transverse rod and the armrest upright rod is greater than the length between a bottom end of the upper reinforcing frame and a top end of the seat cushion frame, such that the armrest transverse rod and the armrest upright rod can form an inverted V-shaped structure;

the lengths of the armrest transverse rod and the armrest upright rod are too long, thereby forming a locking and pressing effect therebetween, so that the armrest transverse rod and the armrest upright rod cannot be fully expanded in a horizontal manner, thus forming an inverted V-shaped structure, so that the armrest transverse rod and the armrest upright rod can be adapted to function as an armrest automatically when the bed chair structure is in turn converted from a bed into a chair.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a first conventional bed chair structure in accordance with the prior art;

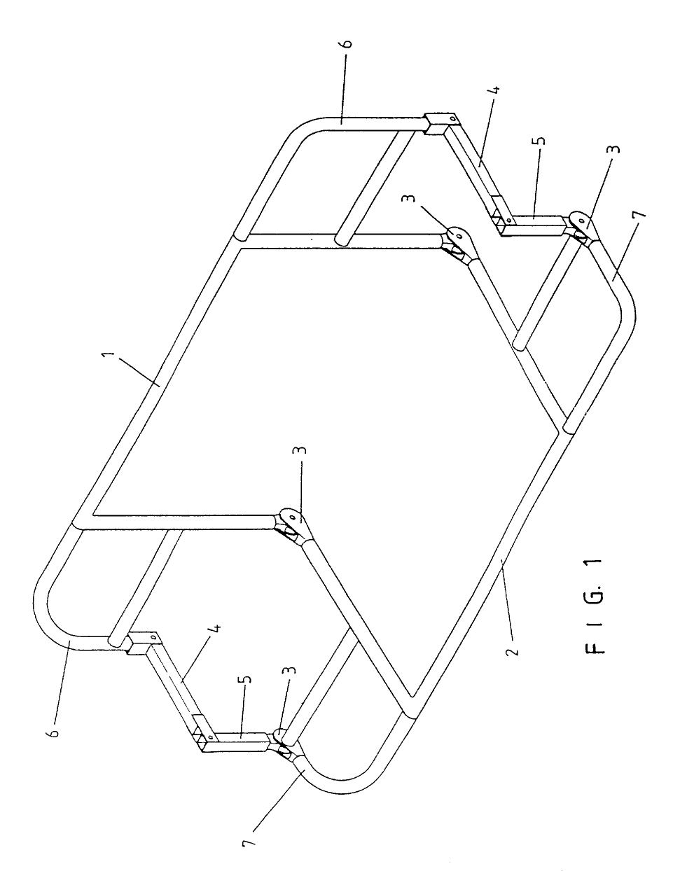

FIG. 2 is a perspective view of a first conventional bed chair structure in accordance with the prior art;

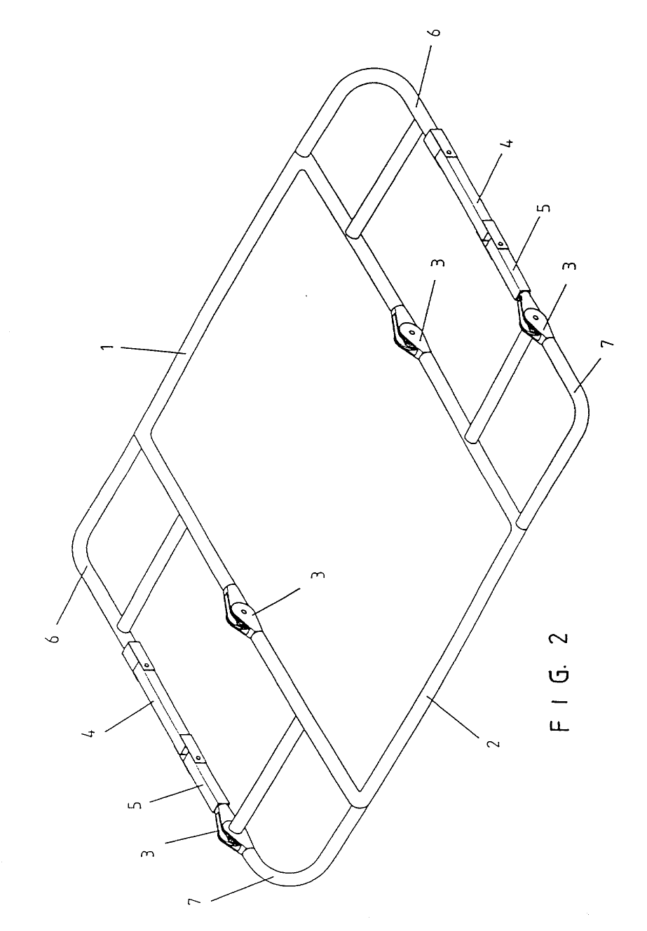

FIG. 3 is a side plan operational view of the first conventional bed chair structure as shown in FIG. 1;

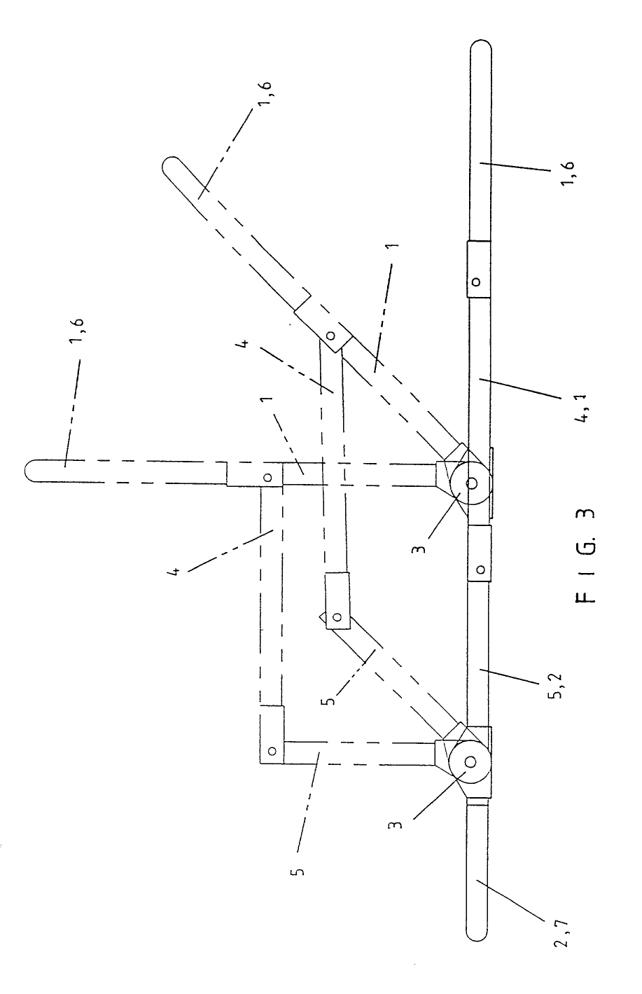

FIG. 4 is a perspective view of a second conventional bed chair structure in accordance with the prior art;

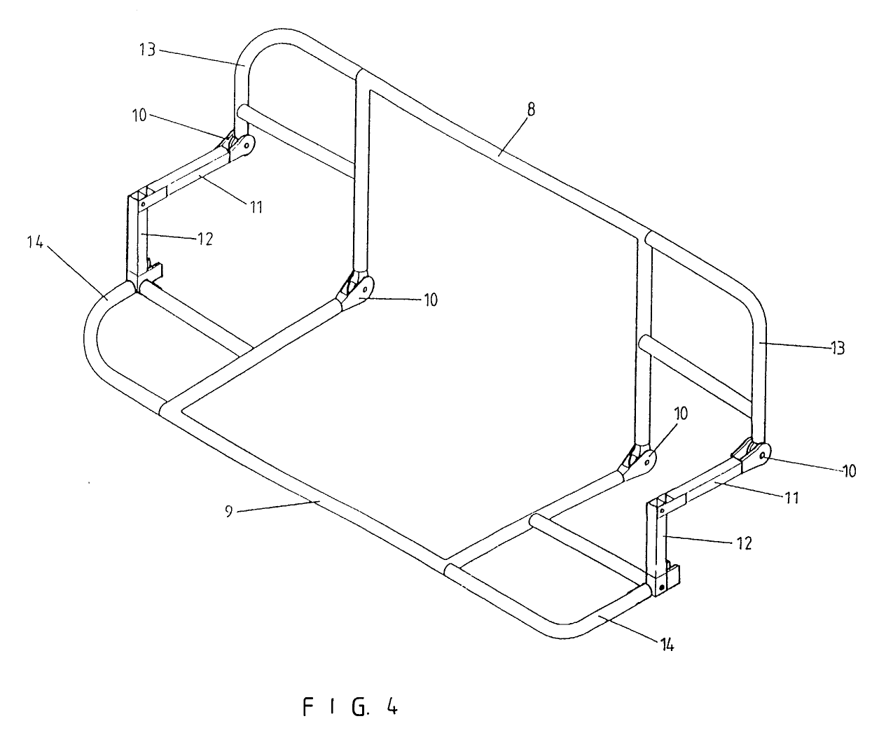

FIG. 5 is a perspective view of a second conventional bed chair structure in accordance with the prior art;

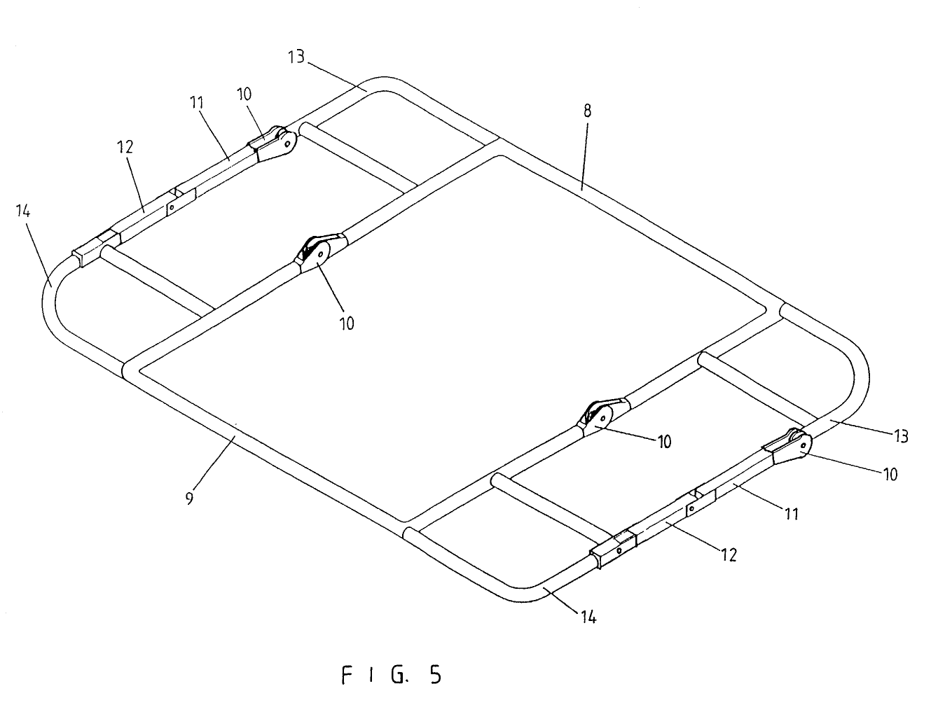

FIG. 6 is a side plan operational view of the second conventional bed chair structure as shown in FIG. 4;

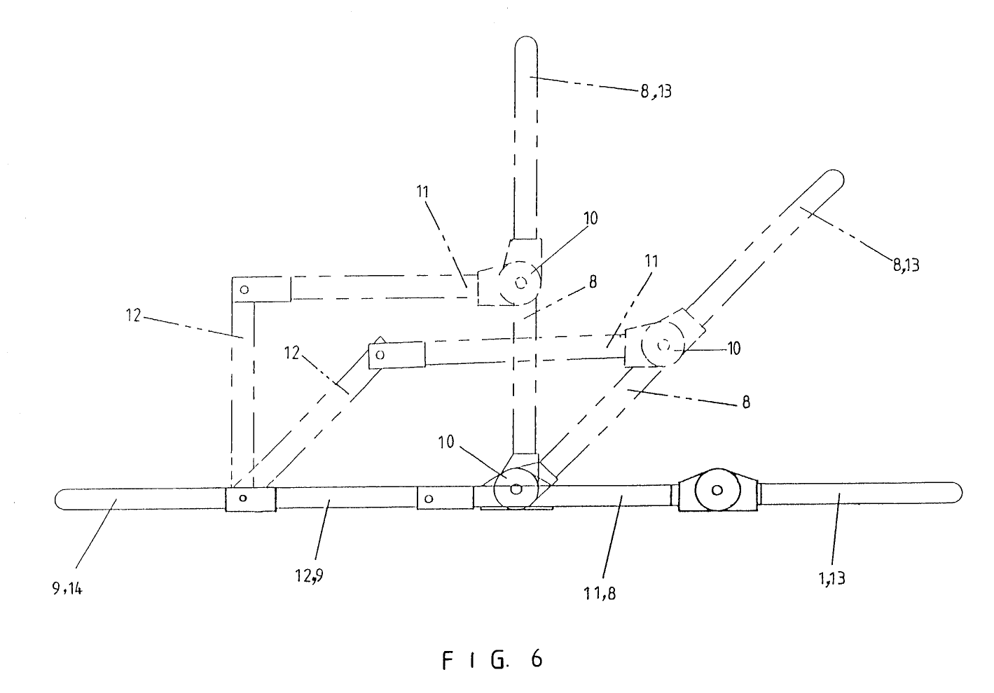

FIG. 7 is an exploded perspective view of a third conventional bed chair structure in accordance with the prior art;

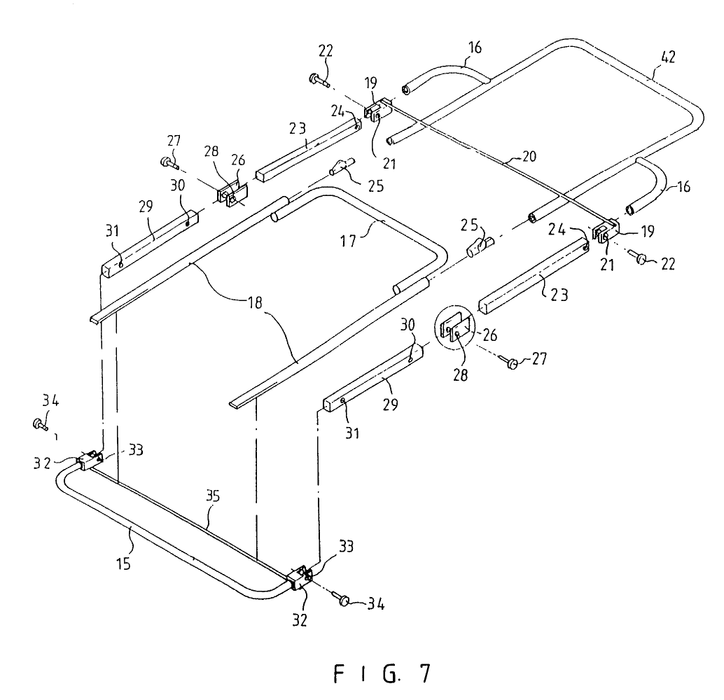

FIG. 8 is a partially enlarged view of the third conventional bed chair structure as shown in FIG. 7;

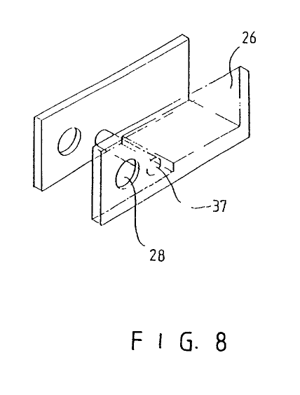

FIG. 9 is a perspective assembly view of the third conventional bed chair structure as shown in FIG. 7;

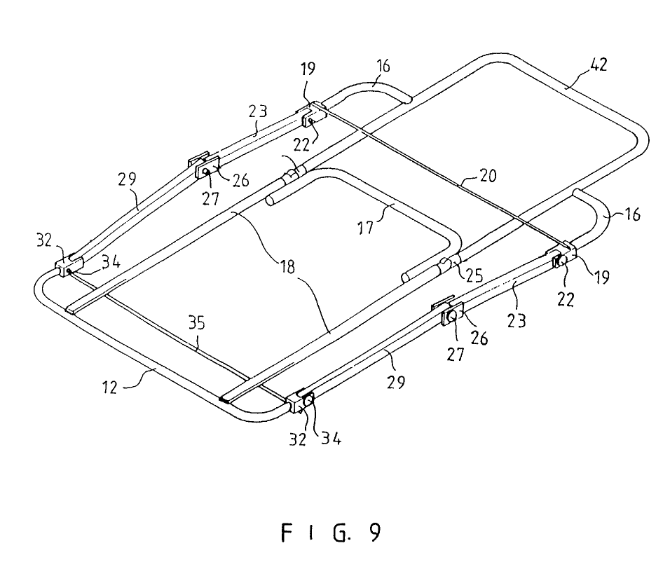

FIG. 10 is a side plan operational view of the third conventional bed chair structure as shown in FIG. 9;

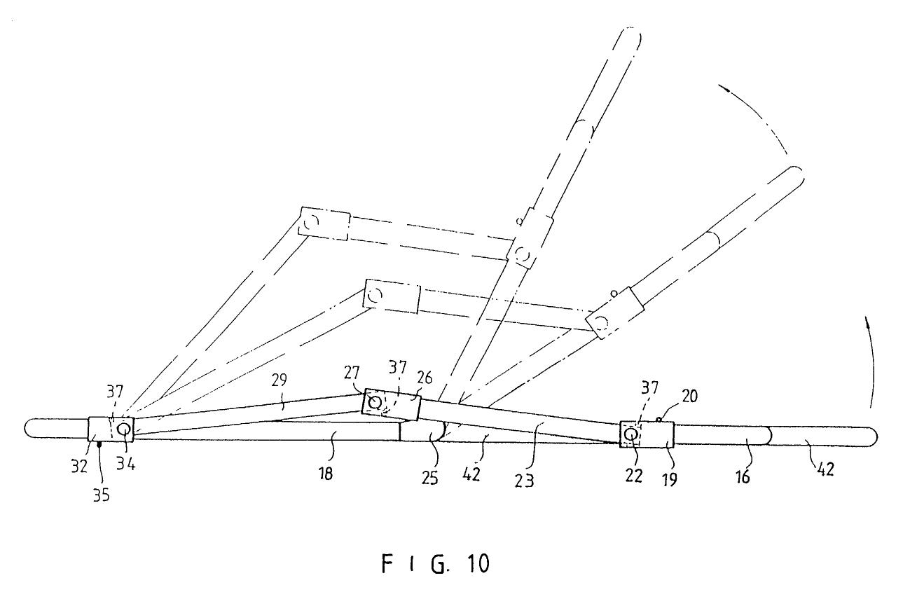

FIG. 11 is an exploded perspective view of a fourth conventional bed chair structure in accordance with the prior art;

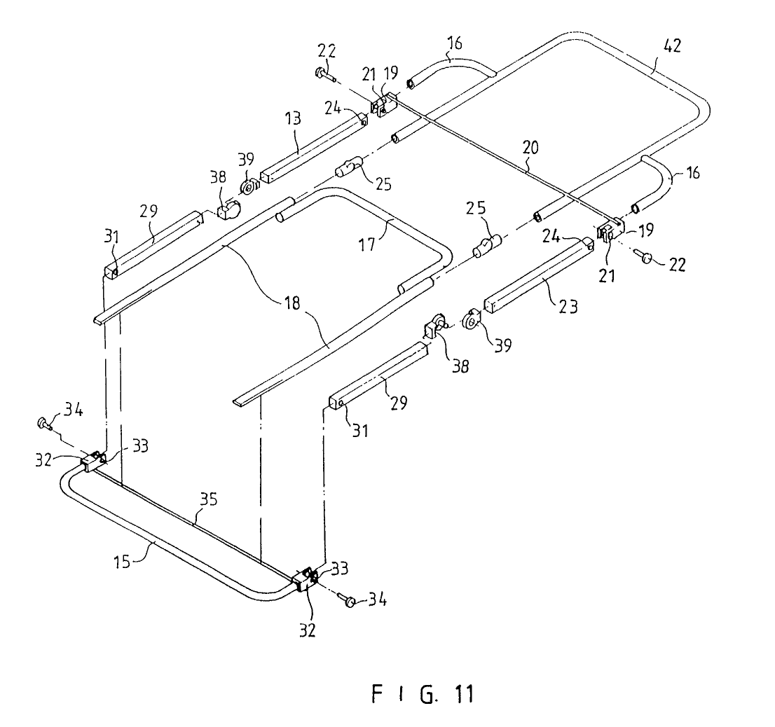

FIG. 12 is a partially enlarged view of the fourth conventional bed chair structure as shown in FIG. 11;

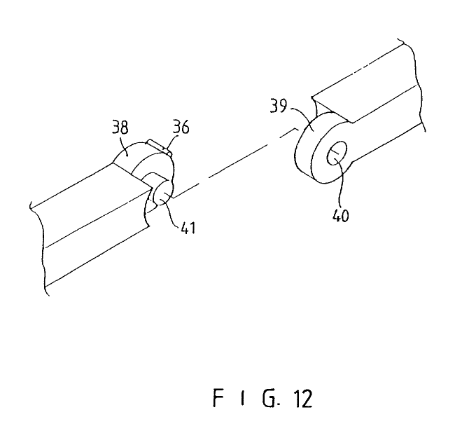

FIG. 13 is a perspective assembly view of the fourth conventional bed chair structure as shown in FIG. 11;

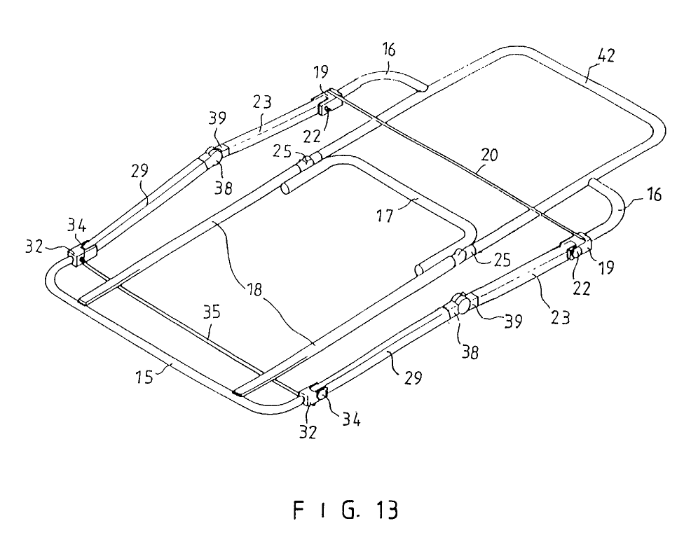

FIG. 14 is a side plan operational view of the fourth conventional bed chair structure as shown in FIG. 13;

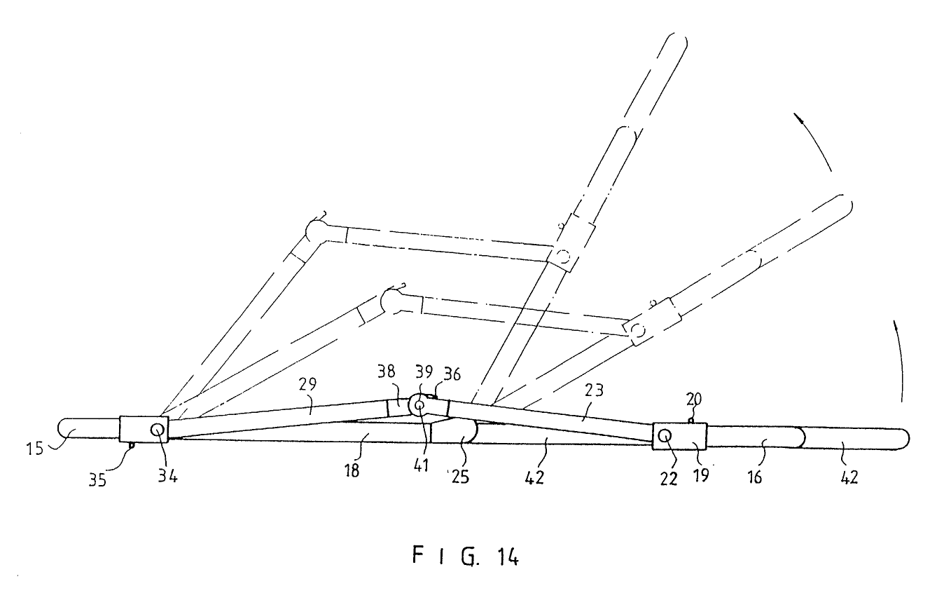

FIG. 15 is an exploded perspective view of a bed chair structure in accordance with a first embodiment of the present invention;

FIG. 16 is a perspective assembly view of the bed chair structure as shown in FIG. 15;

FIG. 17 is a side plan operational view of the bed chair structure as shown in FIG. 16;

FIG. 18 is an exploded perspective view of a bed chair structure in accordance with a second embodiment of the present invention;

FIG. 19 is a perspective assembly view of the bed chair structure as shown in FIG. 18; and

FIG. 20 is a side plan operational view of the bed chair structure as shown in FIG. 19.

### DETAILED DESCRIPTION OF THE INVENTION

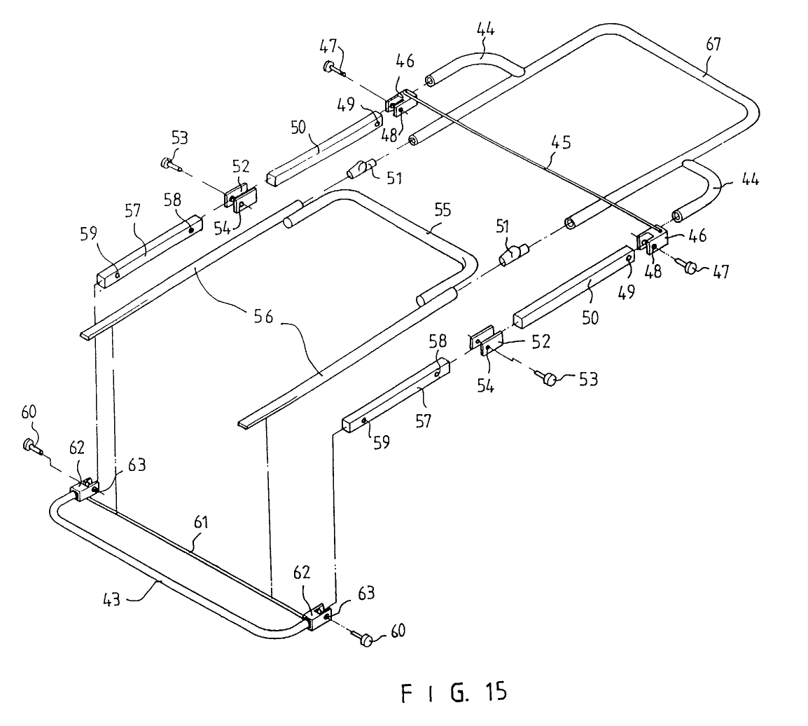

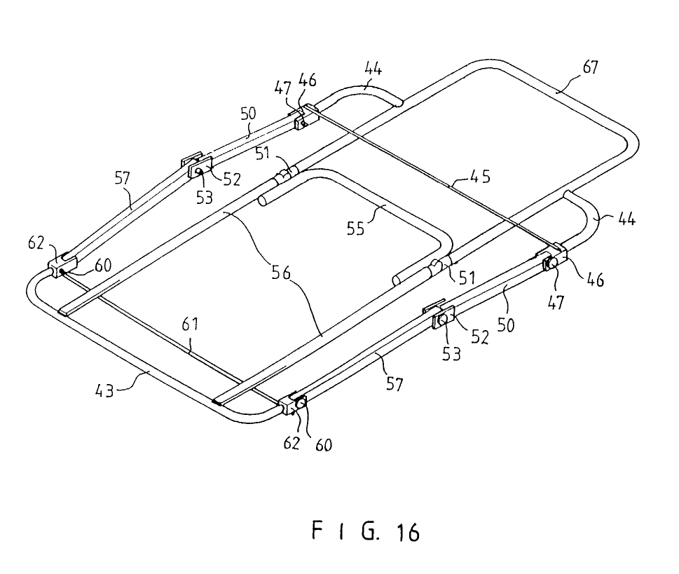

Referring to the drawings and initially to FIGS. 15-17, a bed chair structure in accordance with a first embodiment of the present invention is disclosed. According to the principle of triangle, the sum of the lengths of two sides of the triangle is greater than the length of the third side of the triangle. Thus, in the bed chair structure of the present invention, the total length of the armrest transverse rod 50 and the armrest upright rod 57 is greater than the distance or length between the bottom end of the upper reinforcing frame 44 and the top end of the seat cushion frame 43, such that the armrest transverse rod 50 and the armrest upright rod 57 can form an inverted V-shaped structure.

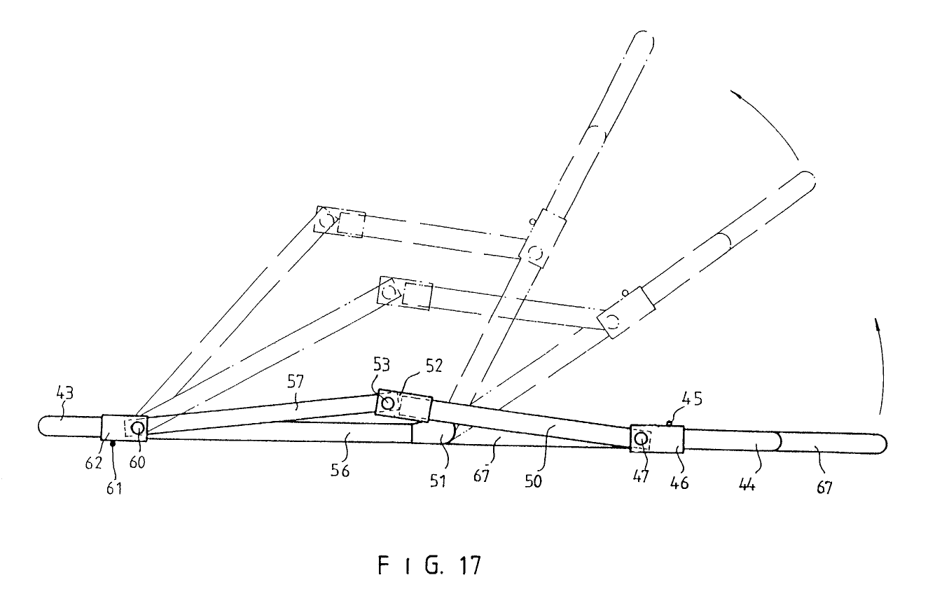

As shown in FIG. 17, the lengths of the armrest transverse rod 50 and the armrest upright rod 57 are too long, thereby forming a locking and pressing effect therebetween, so that the armrest transverse rod 50 and the armrest upright rod 57 cannot be fully expanded in a horizontal manner, thus forming an inverted V-shaped structure, so that they can be adapted to function as an armrest automatically when the bed chair structure is converted from a bed into a chair.

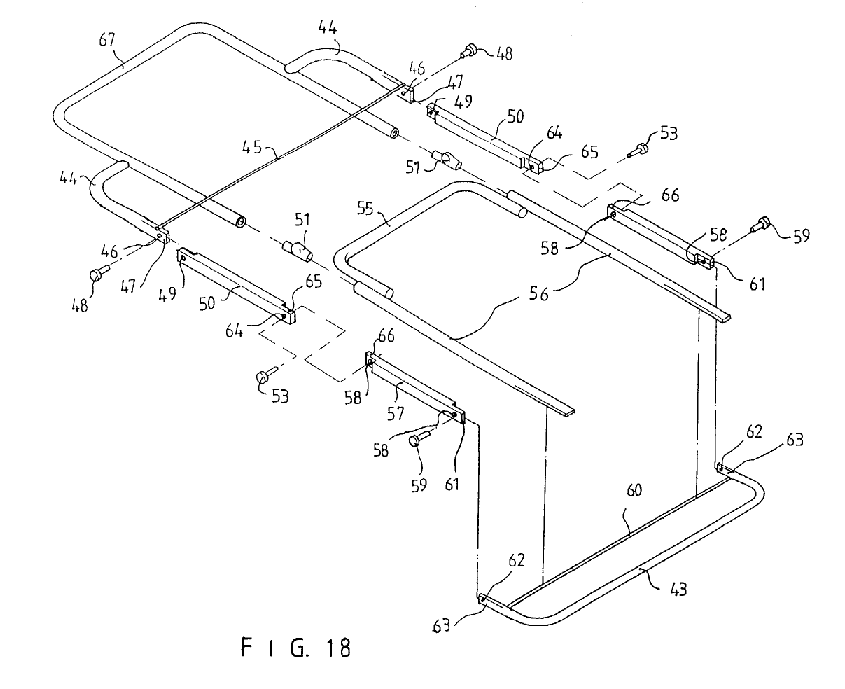

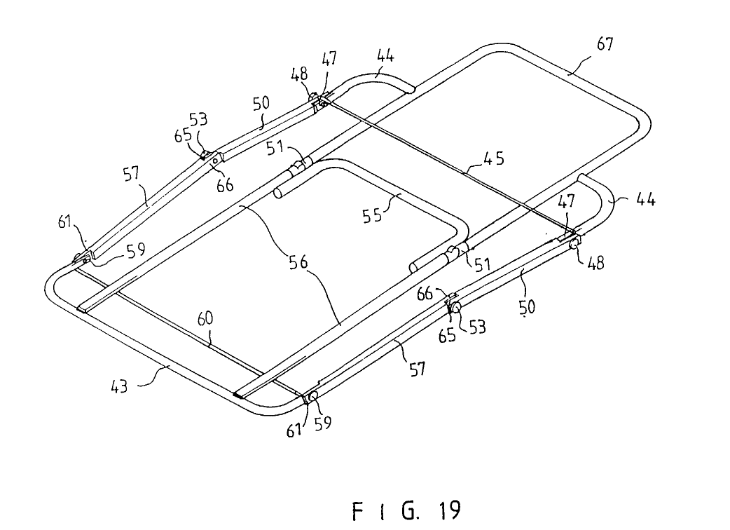

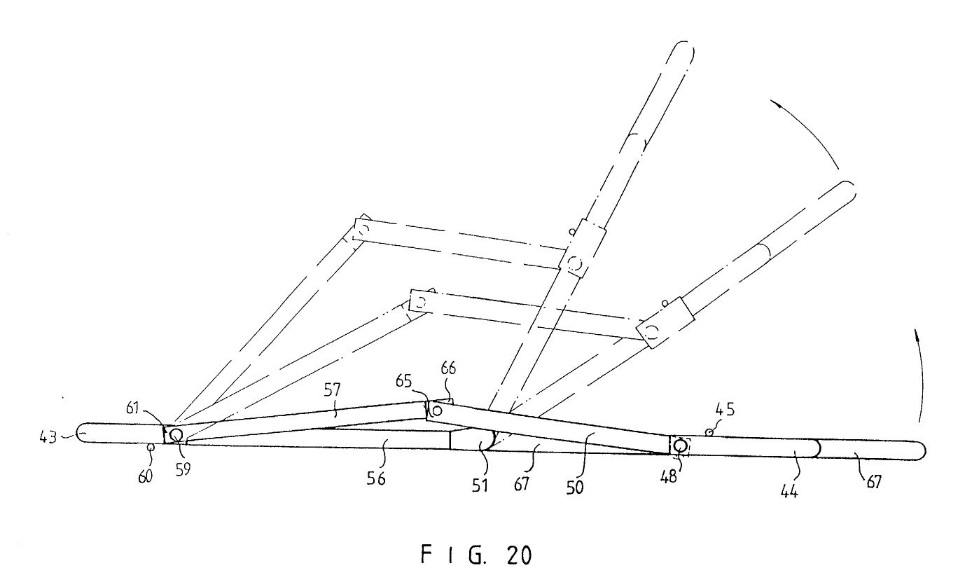

Referring to the drawings and initially to FIGS. 18-20, a bed chair structure in accordance with a second embodiment of the present invention is disclosed. The rear end of the armrest transverse rod 50 and the front end of the armrest upright rod 57 are formed with a cutout respectively so that the rear end of the armrest transverse rod 50 and the front end of the armrest upright rod 57 can co-operate with each other. A rivet 53 in turn extends through a through hole 64 defined in the rear end of the armrest transverse rod 50 and a through hole 58 defined in the front end of the armrest upright rod 57.

Accordingly, the bed chair structure of the present invention can largely reduce the numbers of the normal directional gears, thereby decreasing the cost of fabrication. In addition, the armrest transverse rod and the armrest upright rod can form an inverted V-shaped structure so as to function as an armrest automatically when the bed chair structure is converted from a bed into a chair.

Although the invention has been explained in relation to its preferred embodiment as mentioned above, it is to be understood that many other possible modifications and variations can be made without departing from the scope of the present invention.

What is claimed is:

1. A bed chair structure comprising:
a seat cushion frame having two legs;
two armrest upright rods each having a first end pivoted with a respective leg of the seat cushion frame;
a seat backrest frame having two legs;
two upper reinforcing frames each having a first end secured on a respective leg of the seat backrest frame; and
two armrest transverse rods each having a first end pivoted with a second end of a respective upper reinforcing frame and a second end pivoted with a second end of a respective armrest upright rod;
wherein, according to the principle of triangle, the sum of the lengths of two sides of the triangle is greater than the length of the third side of the triangle;
a total length of the armrest transverse rod and the armrest upright rod is greater than the length between a bottom end of the upper reinforcing frame and a top end of the seat cushion frame, such that the armrest transverse rod and the armrest upright rod can form an inverted V-shaped structure;
the lengths of the armrest transverse rod and the armrest upright rod are too long, thereby forming a locking and pressing effect therebetween, so that the armrest transverse rod and the armrest upright rod cannot be filly expanded in a horizontal manner, thus forming an inverted V-shaped structure, so that the armrest transverse rod and the armrest upright rod can be adapted to function as an armrest automatically when the bed chair structure is in turn converted from a bed into a chair.

2. The bed chair structure in accordance with claim 1, wherein a rear end of the armrest transverse rod and a front end of the armrest upright rod are formed with a cutout respectively so that the rear end of the armrest transverse rod and the front end of the armrest upright rod can co-operate with each other, a rivet in turn extends through a through hole defined in the rear end of the armrest transverse rod and a through hole defined in the front end of the armrest upright rod.
